(19) United States
(12) Patent Application Publication
(10) Pub. No.: US 2018/0098529 A1
(43) Pub. Date: Apr. 12, 2018

(54) SUPPORT FOR NATURAL BAIT WITH FIXATION SYSTEM, PROTECTION AND OSCILATORY MOTION DURING FISHING

(71) Applicants: Davi Quintella de Sousa, Rio de Janeiro (BR); Flávio Campos Reis, Rio de Janeiro (BR)

(72) Inventors: Davi Quintella de Sousa, Rio de Janeiro (BR); Flávio Campos Reis, Rio de Janeiro (BR)

(21) Appl. No.: 15/620,569

(22) Filed: Jun. 12, 2017

(30) Foreign Application Priority Data
Oct. 6, 2016 (BR) 102016013432-3

(51) Int. Cl. A01K 83/06

(52) U.S. Cl. CPC A01K 83/06

(57) ABSTRACT

To facilitate, through two supports, the fixation of the natural bait, protecting it against the friction of the water during the fishing and giving it oscillatory motion in order to reproduce the swimming, to attract the fish to be fished. For such, both supports have eyelets to receive the fishhook, and have curved bodies with respective nozzles, partially receives of the bait's head. The lashing occurs through the involvement of the gills, in the case of support through the use of elastic loop and in the case of support through the use of wire.

### FIELD OF THE INVENTION

This descriptive report refers to an application of invention patent to a support for natural baits, basically composed by a nozzle provided of eyelet (to receive the fishhook), gradually opening its curved body and, in the opposed side, forming an open nozzle.

The support has a version to fix the bait through an elastic loop and another version to fix the bait through a wire, being in both cases, such fixation elements passed through the bait's gills.

Through such fixation, when in water, the bait is flexibly kept simulating the oscillatory motion in an efficient and eye-catching manner, to call the attention of the fish to be captured.

### BACKGROUND OF THE INVENTION

As it is known, sport fishing has gained fans very fast, and groups extremely organized and with strong structure for trips, accommodation, meals, and the sports itself have been created.

Such modality of fishing, in fact, occurs with the natural bait (fixed to the fishhook) being dragged through the water in a system called “currico” here in Brazil, and “trolling” abroad.

Upon the start of such activity, the fishhooks to secure such natural baits were of “J” type, that is, conventional fishhooks, which required consuming preparation, being secured by the line and introduced in the animal's body (bait), Such line is externally directed, exiting through the fish's mouth (bait), which is sewed with wire or elastic so that water does not enter, (when submerged and being dragged in motion). By the characteristics of such fishhook of “J” type, after the capture of the fish (reason of the fishing), the same died. It is because after swallowing the bait, such type of fishhook remains trapped in the stomach (or “embuchado” (stuffed)—term used by the fishermen/sportsmen) and, even following returned to nature, the animal (reason of fishing) ends up dying, which is not, evidently, the purpose of such practice, nor ecologically correct. The preparation of the bait with such type of “J” fishhook is showed by FIG. 1, only entered as example in such application of patent.

To avoid the fish's death (reason of fishing), a type of fishhook called “circular” was developed, which currently is the most used type worldwide, through which the animal (reason of fishing) is kept caught by the mouth and not by the stomach, being, currently, the only fishhook accepted for fishing competitions and tournaments worldwide. Although being more simple, the preparation of the bait through such circular fishhook still is consuming. For such, the eyes shall be removed, passing the line through the lead weight, and then through the gills, passing it through the eyes and making a series of knots for lashing of the lead weight on the bait's head, then closing its mouth (so that water does not enter). Finally, such line is twisted on the bait's head for the formation of a kind of support, in order to finally fix it on the circular fishhook. The preparation of the bait with such circular fishhook is showed by FIG. 2, only entered as example in such application of patent.

Therefore, in addition to be consuming, such conventional “lashings” do not guarantee the protection to the bait's body, which ends up deteriorating very fast and, additionally, for being directly fixed on the fishhook, it does not offer motion that simulates swimming, to more efficiently call the attention of the fish to be captured.

### SUMMARY OF THE INVENTION

The support in question, reason of such application of patent, was developed also to use in circular fishhook and provides any person with a quick preparation of the natural bait, even not having knowledge on fishing. After easily prepared, the support will give the bait an hydrodynamic performance very superior to other methods already existing since, by the proposed fixation the swimming of a live fish will be simulated, very close to the real movement, in nature.

So, the attention of the fish to be fished will be called in a more assertive manner, and the same, after the capture will be returned to the nature without those fatal sequels respecting, therefore, the conservation rules for such modality of “fish and release”.

In summary, the support has an open nozzle to receive the bait's head that, following, is easily secured through its gills, keeping the remaining of the body free. The fixation may occur through an elastic loop or through wire, passing between the gills and fixing the fish to the support in a flexible manner. After fixed on the fishhook through its eyelet, during the fishing, the support will absorb the water friction against the bait, and, through its flexible fixation, it will enable oscillatory motions simulating the action of fins of a live fish, in order to call the attention of the fish reasons of fishing.

### BRIEF DESCRIPTION OF THE DRAWINGS

Superficially explaining, the support, in its two versions, becomes to be explained in further details through the attached figures.

FIGS. 1 and 2, as previously described, refer to the state of the art.

The figures following listed, from 3 to 22, refer to the bait, reason of such application of patent, through which the following are seen:

FIG. 3—view in perspective of the support, in a first version, from its eyelet, for fixation of the bait through elastic loop. Next to it, in 3A, the support in rendered view is showed;

FIG. 4—view in perspective of the support of such first view, showing from the receiving nozzle of the bait's head. Next to it, in 4A, the support in rendered view is showed;

FIG. 5—view in perspective of the support, in its second version, from its eyelet, for fixation of the bait through a wire. Next to it, in 5A, the support in rendered view is showed;

FIG. 6—view in perspective of the support in its second version, showed from the receiving nozzle of the bait's head. Next to it, in 6A, the support in rendered view is showed;

The following figures, listed from 7 to 21, show the support system in its version for fixation of the bait, by elastic loop:

FIG. 7—it shows the support with its nozzle provided of hole on the bottom, to which the elastic loop is aligned;

FIG. 8—it shows an end of the loop passing through the hole;

FIG. 9—it shows the loop fixed on the hole of the support;

FIG. 10—it shows the loop being directed to pass through the lead weight;

FIG. 11—it shows the loop fixed on the support and already passed through the lead weight;

FIG. 12—it shows the free end of the loop, after passage through the lead weight, before involving the bait's gills;

FIG. 13—it shows the passage of the loop through the gills;

FIG. 14—it shows the loop already fixed to the gills and directed to the rod of the top part of the nozzle;

FIG. 15—it shows the loop fixed between the hole and the rod, involving the gills and fixing the bait's head;

FIG. 16—view according to previous figure, from another angle;

FIG. 17—it shows the fishhook being inserted through the support eyelet. In such condition, upon the fishing the support avoids the friction with the water and by its flexible fixation gives to the bait's body an oscillation similar to swimming, to attract the fish to be fished.

The figures following listed, from 18 to 22, refer to the support in its version for fixation through wire:

FIG. 18—it shows the support receiving, by two holes of the top part of its nozzle, the passage of a wire;

FIG. 19—it shows the passage of the wire through the bait's gills;

FIG. 20—it shows (the bait was removed for better understanding) that after the passage through the lead weight, one of the ends enlace the hole of the bottom part of the nozzle and is directed to the other end;

FIG. 21—it shows (the bait is in dashed lines) that the ends of the wire were twisted to the locking, so fixing the bait's head;

FIG. 22—it shows the bait ready to use, when it will be kept the same system of avoiding friction of its body with the water and enabling the oscillation similar to swimming, during fishing.

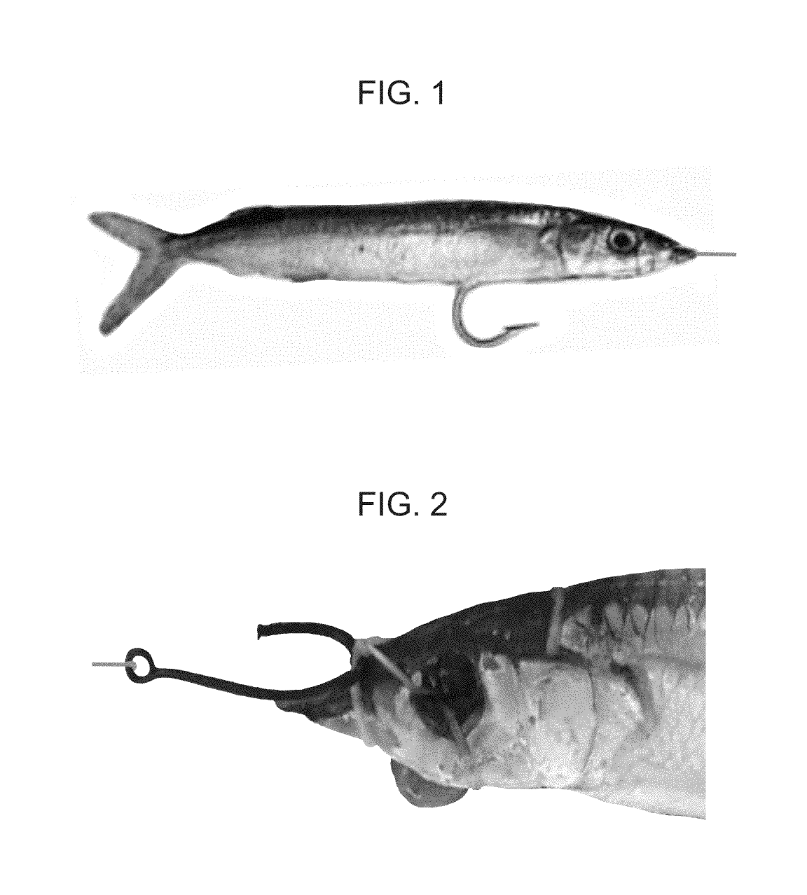

### DETAILED DESCRIPTION

In compliance with the attached drawings, the “SUPPORT FOR NATURAL BAIT, WITH FIXATION SYSTEM, PROTECTION, AND OSCILLATORY MOTION DURING FISHING”, subject matter of this application of invention patent, consists of two supports, being one support (1) for fixation of the bait by elastic loop (L) and one support (1a) for fixation of the bait through wire (AR).

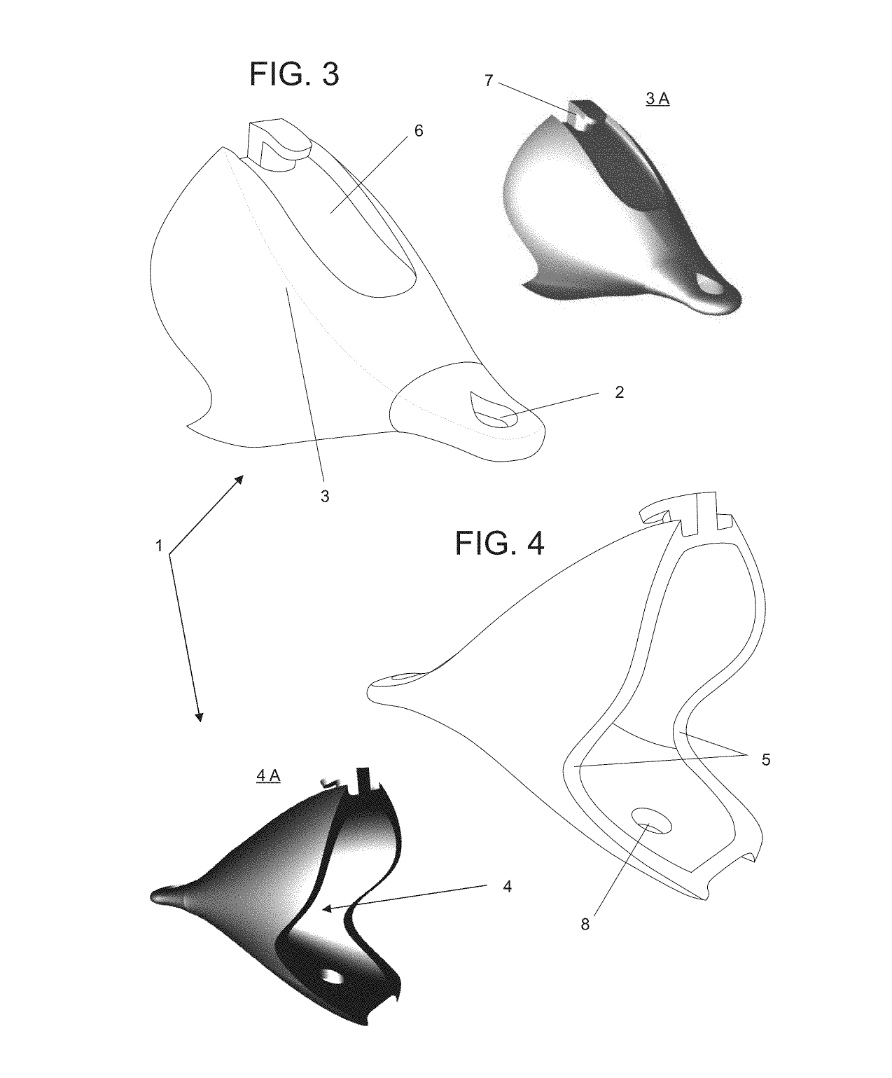

The support (1), as observed by FIGS. 3 and 4, has an eyelet (2) in one of its ends, gradually opening for formation of the curved body (3), provided of a rear nozzle (4) fully open, with retreated intermediate part (5). Such retreated intermediate part (5) limits, on the rear nozzle (4), a top portion provided of recess (6) incorporating a “L” shaped rod (7) and a bottom portion hollowed by a hole (8).

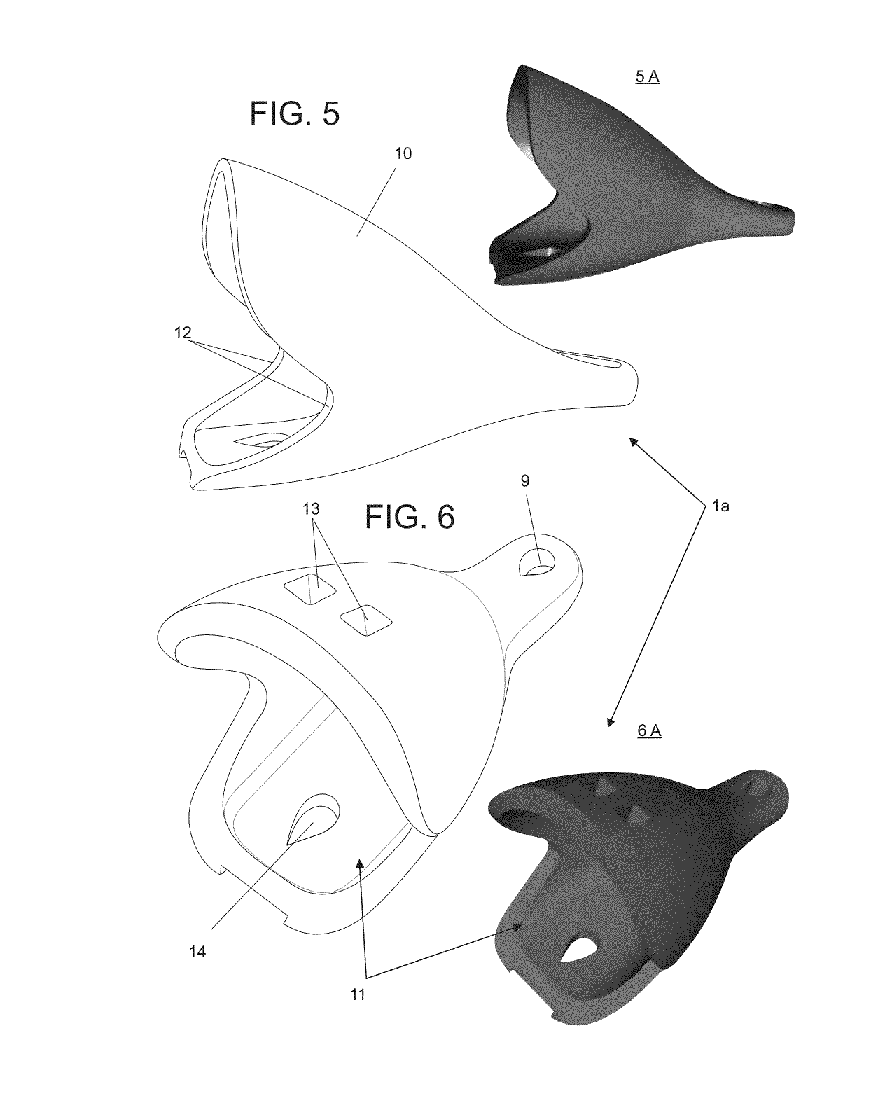

The support (1a), as it is observed through FIGS. 5 and 6, equally has eyelet (9) in one of its ends, gradually opening to the formation of the curved body (10), provided of a rear nozzle (11) fully open, also with retreated intermediate part (12), defining top portion hollowed by two holes (13) and bottom portion hollowed by a hole (14). So constituted, the supports (1) and (1a) will be used in the sport fishing, for fixation of natural baits (IN).

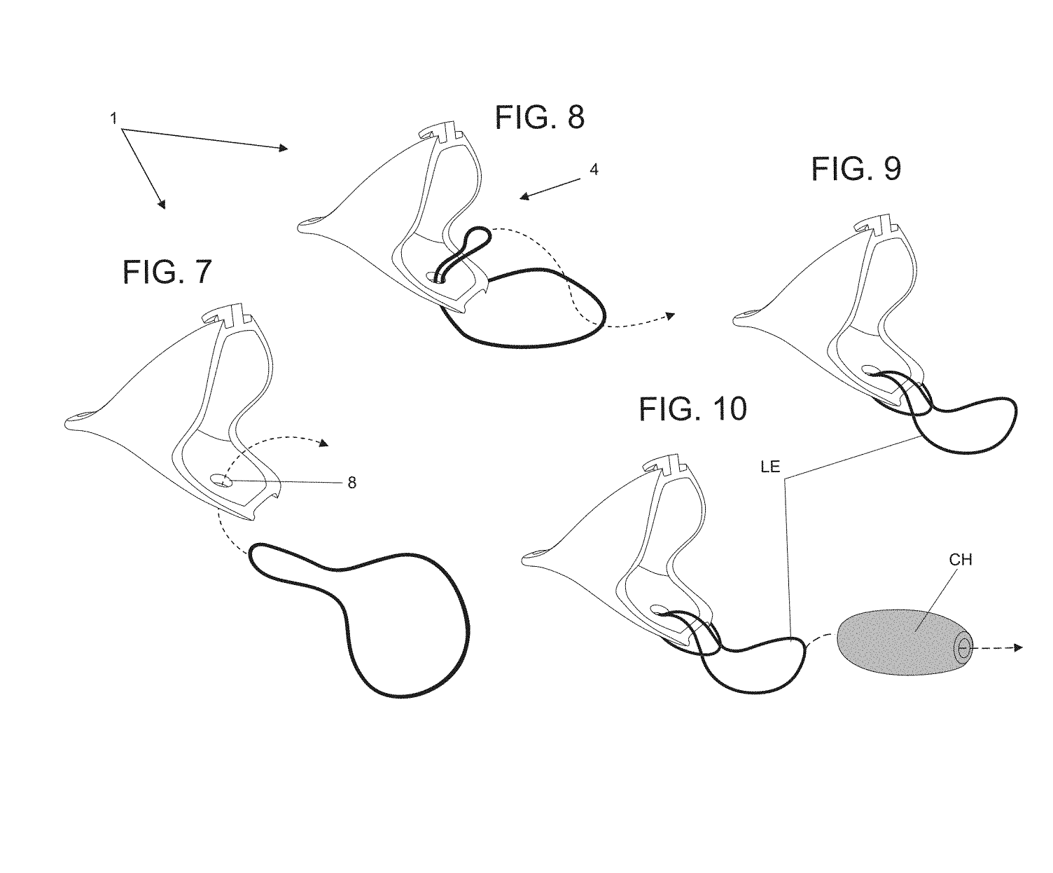

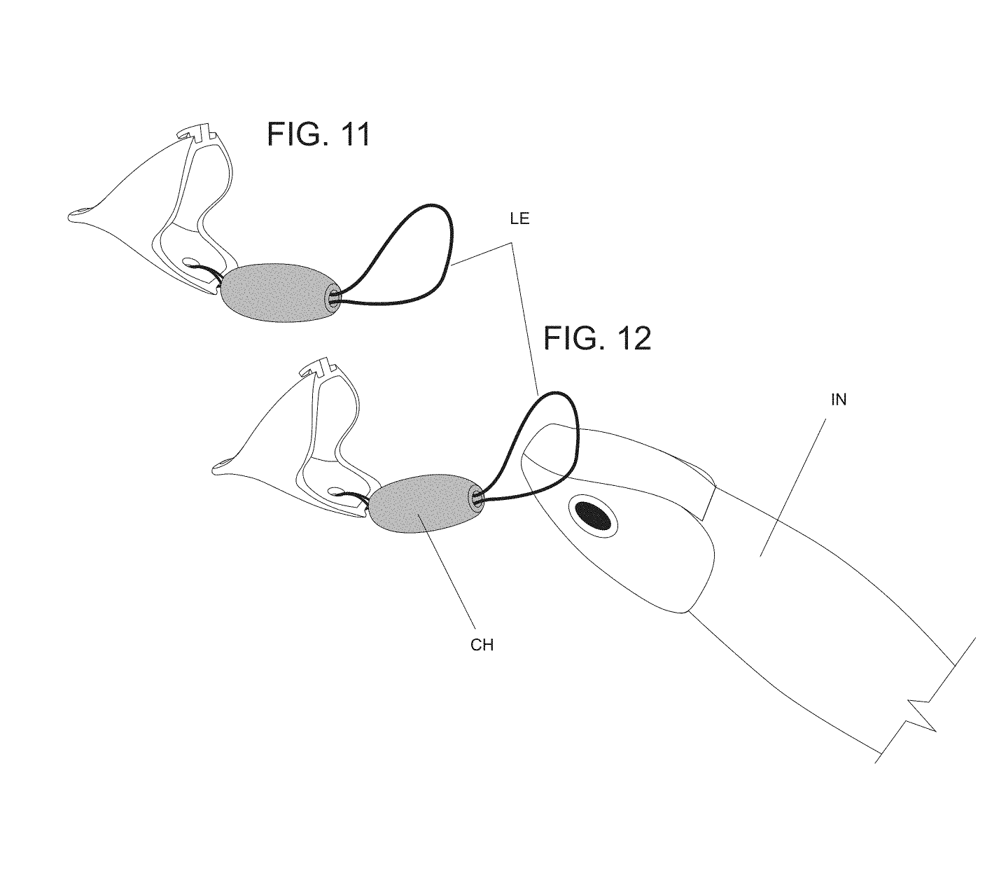

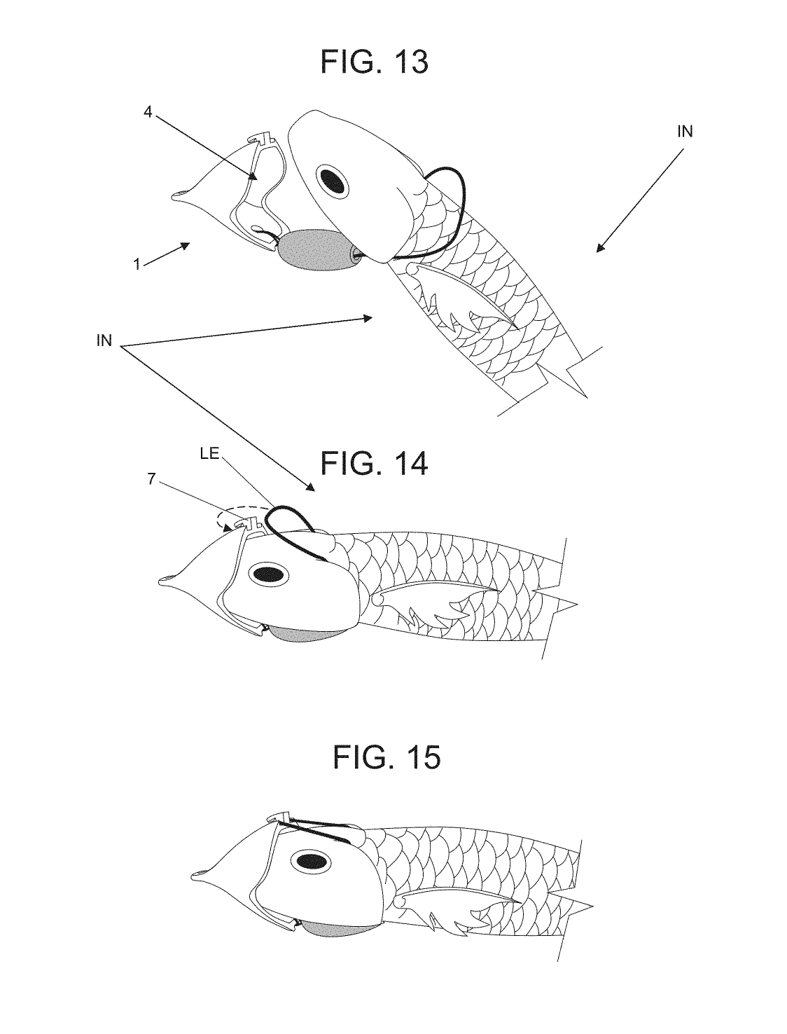

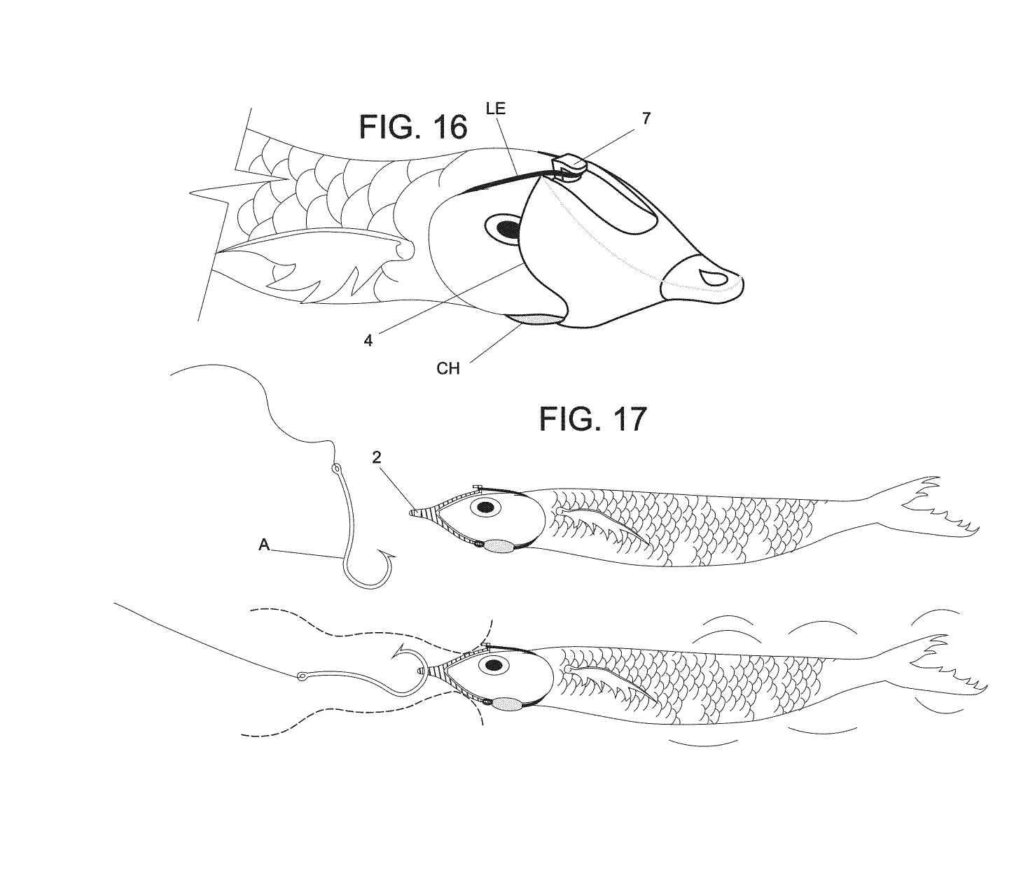

As it is observed, by FIG. 7, the support (1) has the hole (8) of the bottom portion of its receiving rear nozzle (4) of the passage and making of a knot of one of the ends of an elastic loop (LE), as FIGS. 8 and 9 show, which opposite end is passed through the lead weight (CH), as FIGS. 10 and 11 show, being then directed to involve the bait's gills (IN), as FIGS. 12 and 13 show. In such condition, the rear nozzle (4), through the curved body (3) receives the introduction of the bait's mouth (IN) partially and frontally involving it, and, simultaneously fixing it with the anchoring of such end of the elastic loop (LE) on the “L” shaped rod (7), as FIGS. 14 and 15 show. After the bait is fixed (IN), as FIG. 16 shows, the support (1) receives, through its eyelet (2), the fishhook (A) of the fishing line, as FIG. 17 shows.

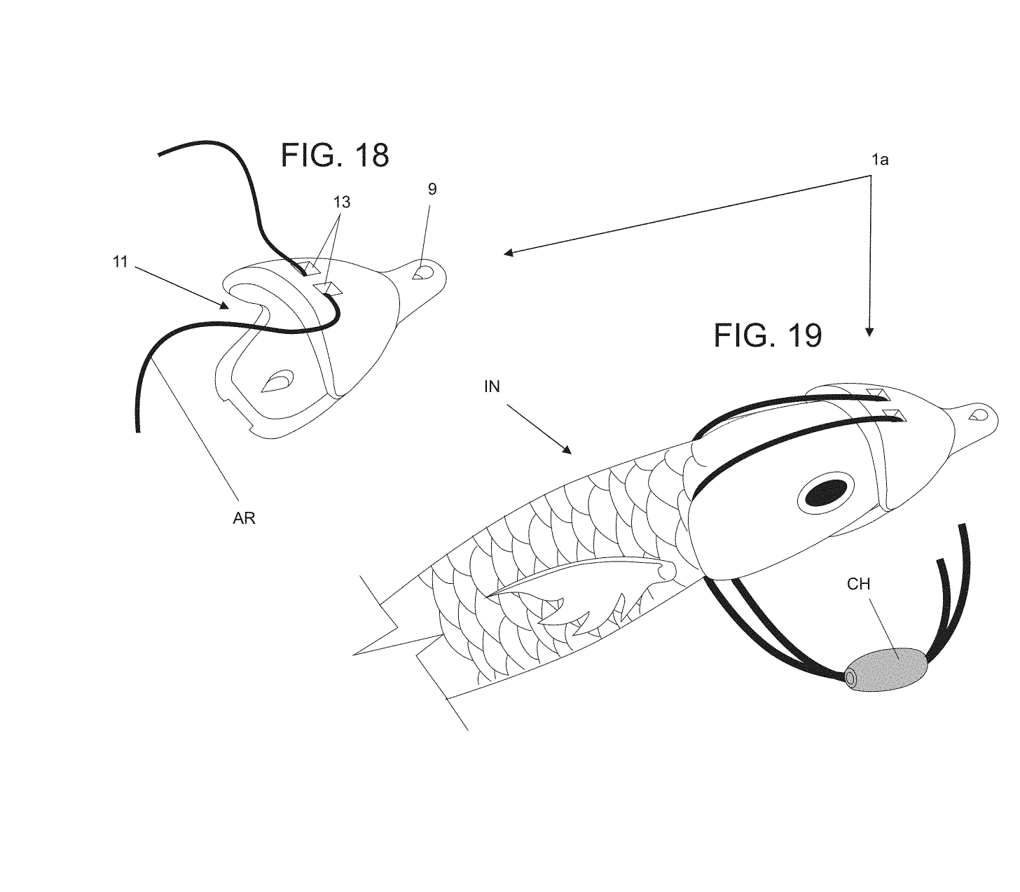

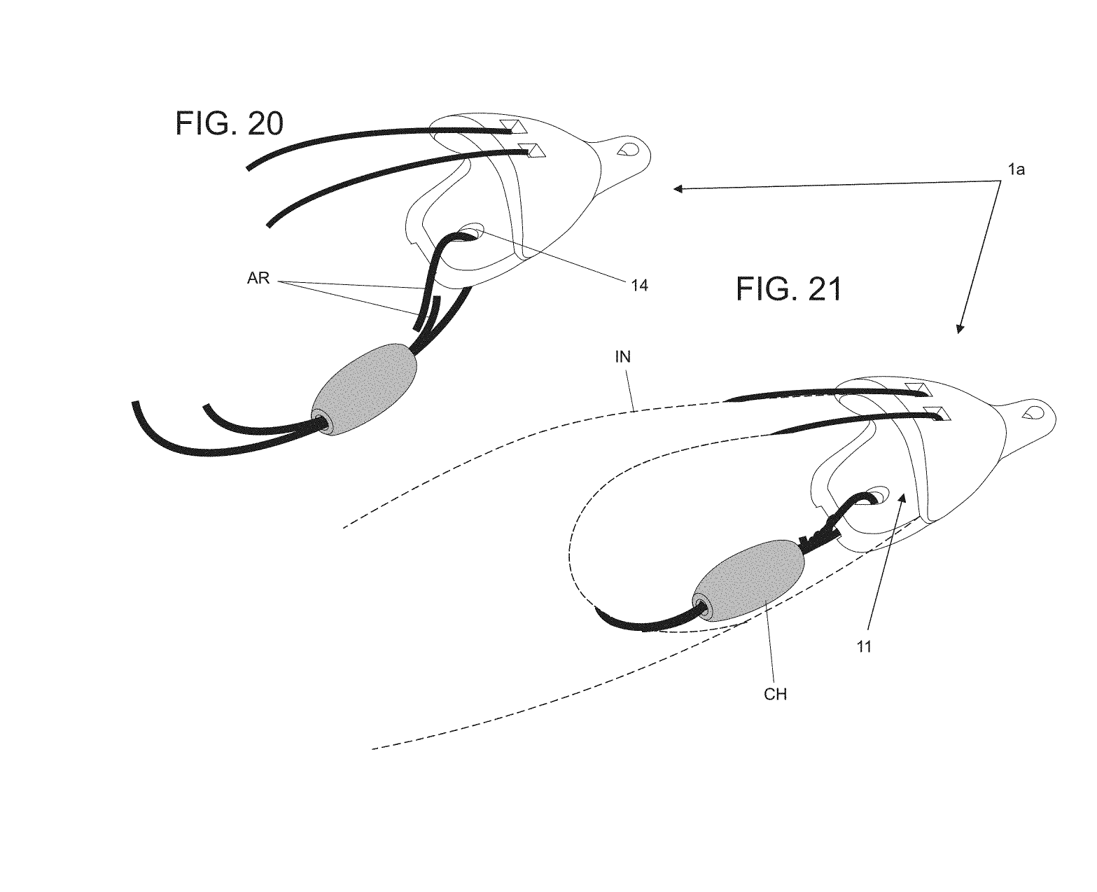

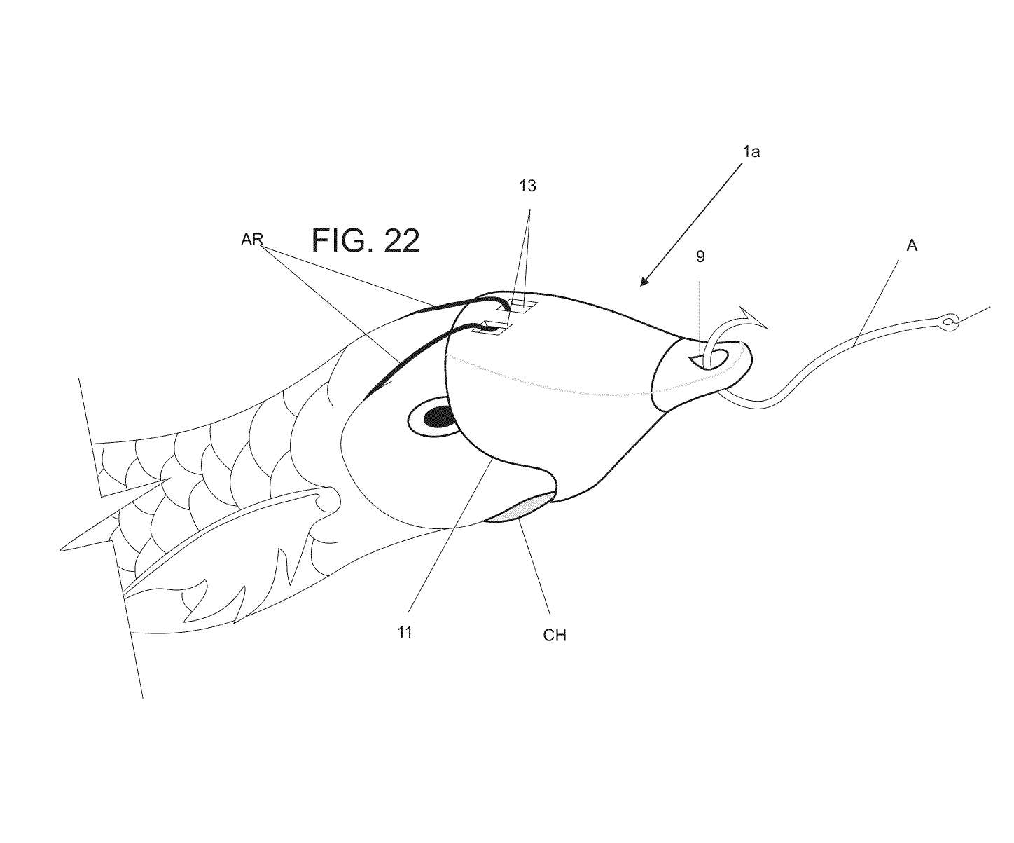

For the use of the support (1a), as FIG. 18 shows, through two holes (13) of the top part of its rear nozzle (11) are passed the ends of the wire (AR), fixing it so that, next, such same ends involve the natural bait's gills (IN) as FIG. 19 shows, and then go beyond the lead weight being directed to the bottom hole (14). In such condition, the rear nozzle (11), through the curved body (10) receives the introduction of the bait's mouth (IN) partially and frontally involving it, simultaneously to the anchoring of one of the ends of the wire in the bottom hole (14) involving it and being brought against the other end, as FIG. 20 shows, before the lead weight (CH), where both ends are twisted, completing the fixation, as FIG. 21 shows. After the bait is fixed (IN), as FIG. 22 shows, the support (1) receives, through its eyelet (2), the fishhook (A) of the fishing line.

As it is observed, from the description and from the figures, the supports (1) and (1a), after fixed in an extremely facilitated and fast manner on the natural bait (IN), protect it from the head against the friction with the water and, as natural complement of its flexible lashing, the body of the said bait (IN) acquires an oscillation similar to swimming, to call the attention of the fish to be fished.

1. Support for natural bait, constituted by a support for fixation of the natural bait through elastic loop, provided of an eyelet in one of its ends, from which its body is characterized for gradually opening forming a rear nozzle fully open, with retreated intermediate part limiting, in the said rear nozzle, a top portion provided of a shoulder incorporating a “L” shaped rod and a bottom portion hollowed by a hole.

2. Support for natural bait, according to claim 1, constituted by a support for fixation of natural bait through a wire, provided of an eyelet in one of its ends, from which its body gradually opens, in curved configuration, forming a rear nozzle fully open, with intermediate retreated part, defining top portion characterized for being hollowed by two holes and bottom portion hollowed by a hole.

3. Fixation system, according to the support of claim 1, characterized by the passage and making of a knot of one of the ends of the elastic loop from the hole of the bottom portion of its rear nozzle, passage of the opposed end through the lead weight, followed by the involvement of the bait's gills simultaneously with the involvement of the latter, partially and frontally through the rear nozzle, anchoring such end of the elastic loop on the “L” shaped rod.

4. Fixation system, according to the support of claim 2, characterized by the passage, through two holes of the top part of the rear nozzle, of the ends of the wire, fixing it, the said ends involving the natural bait's gills, going beyond the lead weight and directed to the bottom hole, simultaneously to the partial and front involvement of the said bait through the rear nozzle, anchoring one of the ends of the wire in the bottom hole involving it, and being brought against the other end, before the lead weight, being the said ends twisted and locked between themselves.

5. Protection and oscilatory motion during fishing, according to claim 1, after the bait has been fixed, on the supports and, both receive through their eyelets and, the fishhook of the fishing line, characterized by the protection of the said bait, from the head, against the friction with the water, simultaneously to the reproduction of the oscillation similar to swimming.
